(19) United States
(12) Patent Application Publication
(10) Pub. No.: US 2026/0008418 A1
(43) Pub. Date: Jan. 8, 2026

(54) VEHICLE REAR VIEW DEVICE

(71) Applicant: TOYOTA JIDOSHA KABUSHIKI KAISHA, Toyota-shi (JP)

(72) Inventor: Eisuke IKENO, Toyota-shi (JP)

(73) Assignee: TOYOTA JIDOSHA KABUSHIKI KAISHA, Toyota-shi (JP)

(21) Appl. No.: 19/089,268

(22) Filed: Mar. 25, 2025

(30) Foreign Application Priority Data
Jul. 5, 2024 (JP) 2024-108778

(51) Int. Cl. B60R 11/02; B60R 11/00; G01S 17/931

(52) U.S. Cl. CPC B60R 11/02; B60R 2011/004; G01S 17/931

(57) ABSTRACT

A vehicle rear view device includes: an exterior cover mounted on an upper portion of a glass on a rear side in such a manner that a longitudinal direction of the exterior cover coincides with a vehicle width direction; a housing portion that is mounted at an outer end in a vehicle width direction of the exterior cover and that is open on a rear side in a vehicle front-rear direction and an outer side in the vehicle width direction; and a sensor housed in the housing portion and supported by a top surface inside the housing portion and an inner side surface in the vehicle width direction of the housing portion.

### CROSS-REFERENCE TO RELATED APPLICATION

This application claims priority to Japanese Patent Application No. 2024-108778 filed on Jul. 5, 2024. The disclosure of the above-identified application, including the specification, drawings, and claims, is incorporated by reference herein in its entirety.

### BACKGROUND

### 1. Technical Field

The present disclosure relates to vehicle rear view devices.

### 2. Description of Related Art

A vehicle rear view device is conventionally known that monitors behind a vehicle by an extendable, rotatable camera imaging unit installed inside a rear spoiler at the rear of the vehicle (see, for example, Japanese Unexamined Patent Application Publication No. 11-245729 (JP 11-245729 A)).

### SUMMARY

For improved detection performance, a sensor such as Light Detection and Ranging (LiDAR) is sometimes used instead of a camera. For example, a sensor such as LiDAR for detecting behind a vehicle is installed on the back side of a rear bumper in order to prevent a positional displacement due to an impact or vibration that occurs on a body (vehicle body) or back glass from an operation of opening and closing a back door. However, there is a demand for further improvement in detection performance, and it is desired to install a sensor on a portion other than a rear bumper (namely, to improve flexibility in sensor installation position).

It is therefore an object of the present disclosure to provide a vehicle rear view device that can improve detection performance of a sensor compared to the case where the sensor is installed on a rear bumper.

In order to achieve the above object, a vehicle rear view device according to a first aspect of the present disclosure includes:
an exterior cover mounted on an upper portion of a glass on a rear side in such a manner that a longitudinal direction of the exterior cover coincides with a vehicle width direction;
a housing portion mounted at an outer end in the vehicle width direction of the exterior cover,
the housing portion being open on a rear side in a vehicle front-rear direction and an outer side in the vehicle width direction; and
a sensor housed in the housing portion, the sensor being supported by a top surface inside the housing portion and an inner side surface in the vehicle width direction of the housing portion.

In the first aspect of the present disclosure, the exterior cover is mounted on the upper portion of the glass on the rear side in such a manner that the longitudinal direction of the exterior cover coincides with the vehicle width direction, and the housing portion that is open on the rear side in the vehicle front-rear direction and the outer side in the vehicle width direction is mounted at the outer end in the vehicle width direction of the exterior cover. The sensor is housed in the housing portion. The sensor is supported by the top surface inside the housing portion and the inner side surface in the vehicle width direction of the housing portion. That is, the sensor is not directly installed on a vehicle body. This can reduce or prevent a positional displacement of the sensor due to vibration etc. that occurs on the vehicle body, so that the sensor can accurately detect not only behind the vehicle but also outside the vehicle in the vehicle width direction. Accordingly, detection performance of the sensor is improved compared to the case where the sensor is installed on a rear bumper.

According to a second aspect of the present disclosure, in the vehicle rear view device of the first aspect, the sensor may not protrude beyond a rear wall surface in the vehicle front-rear direction of the housing portion and an outer wall surface in the vehicle width direction of the housing portion as viewed in plan.

In the second aspect of the present disclosure, the sensor does not protrude beyond the rear wall surface in the vehicle front-rear direction of the housing portion and the outer wall surface in the vehicle width direction of the housing portion as viewed in plan. Therefore, the sensor is less likely to be exposed to direct sunlight, and rain, snow, etc. are less likely to get on the sensor, so that durability of the sensor is improved.

According to a third aspect of the present disclosure, in the vehicle rear view device of the first or second aspect,
an outer wall surface in the vehicle width direction of the housing portion may be tilted inward in the vehicle width direction toward a rear of a vehicle as viewed in plan, and
an outer wall surface in the vehicle width direction of the sensor may be tilted along the outer wall surface in the vehicle width direction of the housing portion as viewed in plan.

In the third aspect of the present disclosure, the outer wall surface in the vehicle width direction of the housing portion is tilted inward in the vehicle width direction toward the rear of the vehicle as viewed in plan, and the outer wall surface in the vehicle width direction of the sensor is tilted along the outer wall surface in the vehicle width direction of the housing portion as viewed in plan. This improves the wind flow at the outer end in the vehicle width direction of the exterior cover during traveling of the vehicle, so that aerodynamic performance of the vehicle is improved.

As described above, the vehicle rear view device according to the present disclosure can improve detection performance of the sensor compared to the case where the sensor is installed on a rear bumper.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a rear portion of a vehicle provided with a vehicle rear view device according to the present embodiment;

FIG. 2 is a schematic perspective view showing a vehicle rear view device according to the present embodiment;

FIG. 3 is a schematic sectional view taken along the arrow X-X in FIG. 2; and

FIG. 4 is a schematic sectional view taken along the arrow Y-Y in FIG. 2.

### DETAILED DESCRIPTION OF EMBODIMENTS

Hereinafter, an embodiment according to the present disclosure will be described in detail with reference to the drawings. For convenience of explanation, an arrow UP shown in the drawings is defined as a vehicle upward direction, an arrow FR is defined as a vehicle forward direction, and an arrow LH is defined as a vehicle leftward direction. Thus, when terms indicating directions, i.e., upward and downward, forward and rearward, and right and left are used in the following description, these mean upward and downward of the vehicle, forward and rearward of the vehicle, and right and left of the vehicle unless otherwise specified. Further, the right-left direction is synonymous with a vehicle width direction.

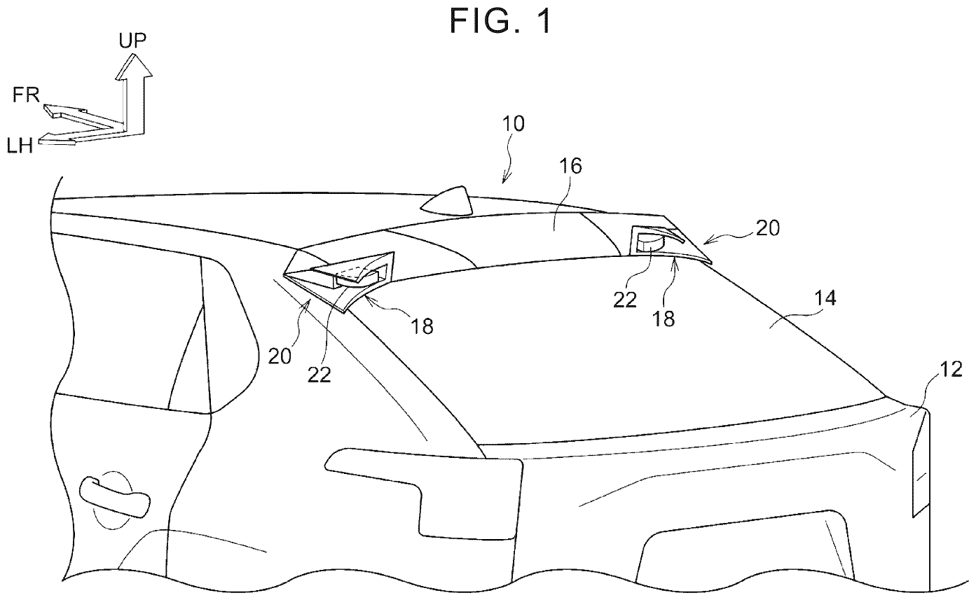

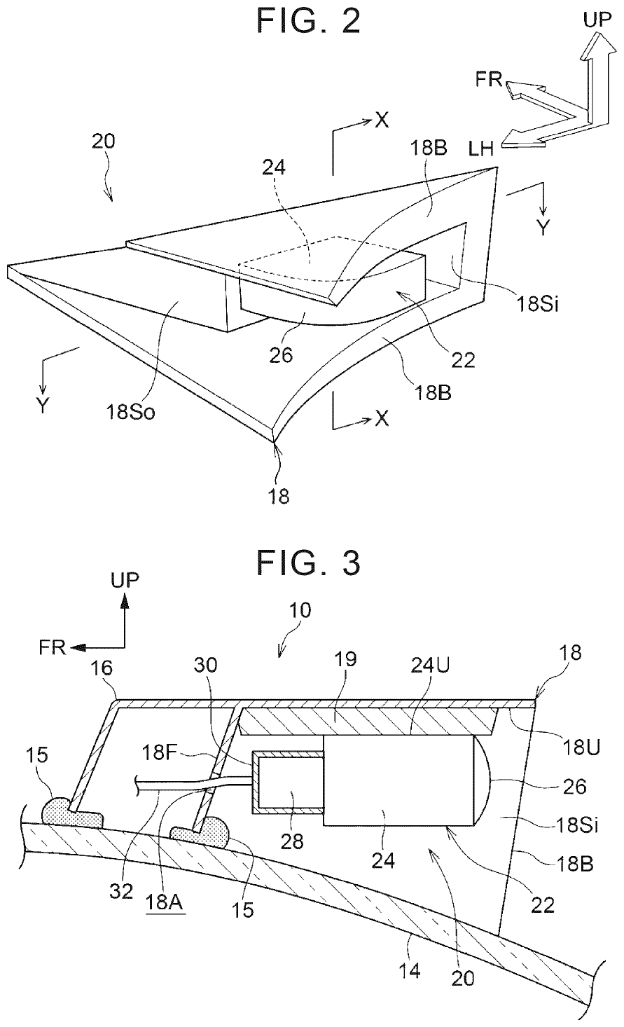

As shown in FIG. 1, a front lower end portion of a rear spoiler 16 as an exterior cover having a vehicle width direction as a longitudinal direction is attached to an upper portion of a back glass 14 in an openable/closable back door 12 of a vehicle 10 via a seal member 15 (see FIG. 3). A housing portion 18 that has a symmetrical housing shape and that is open on the rear side and the outer side in the vehicle width direction is integrally provided at both outer ends in the vehicle width direction of the rear spoiler 16. In FIGS. 2 to 4, the left housing portion 18 is shown as an example.

As shown in FIGS. 1 and 2, the vehicle rear view device 20 according to the present embodiment includes a rear spoiler 16, a pair of right and left housing portions 18 provided at both outer ends in the vehicle width direction of the rear spoiler 16, and sensors 22 such as LiDAR stored in the housing portions 18.

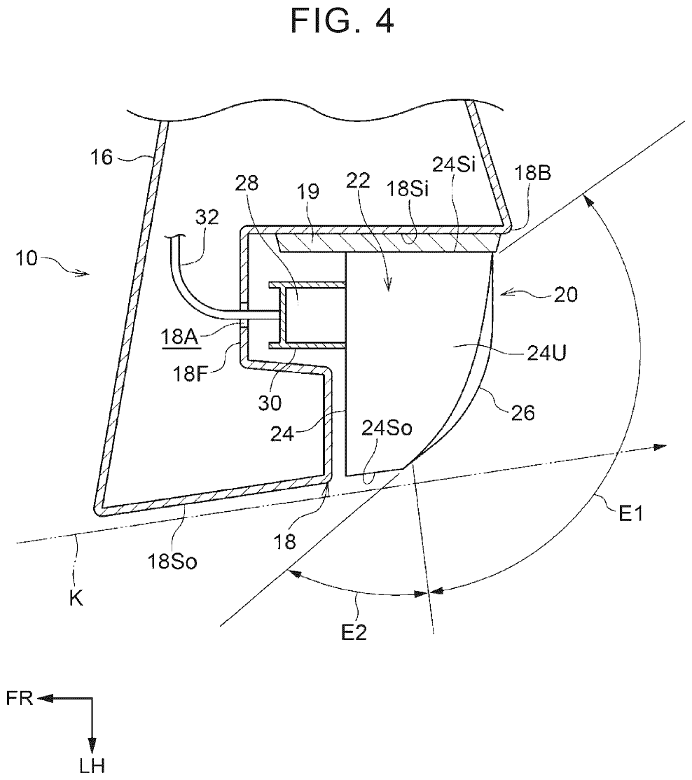

As shown in FIGS. 3 and 4, the sensor 22 has a sensor body 24 in the form of a housing and a connector portion 28, and the sensor housed in the left housing portion 18 and the sensor housed in the right housing portion 18 are disposed symmetrically. The sensor body 24 of each sensor 22 is supported by a top surface (inner surface of upper wall) 18U inside the housing portion 18 and an inner wall surface (hereinafter, referred to as “inner surface”) 18Si in the vehicle width direction of the housing portion.

That is, the upper surface 24U of the sensor body 24 is attached to the top surface 18U of the inside of the housing portion 18 via a vibration absorbing member 19 made of an elastic material or the like (see FIG. 3). An inner wall surface (hereinafter, referred to as an “inner surface”) 24Si in the vehicle width direction of the sensor body 24 is attached to the inner surface 18Si inside the housing portion 18 via a vibration absorbing member 19 made of an elastic material etc. (see FIG. 4). As a result, the sensor body 24 (the sensor 22) is suspended from the top surface 18U and the inner surface 18Si inside the housing portion 18.

A connector portion 28 protruding forward is integrally provided at an inner position in the vehicle width direction on the front portion of the sensor body 24, and the connector portion 28 is electrically connected by being fitted into a socket 30 disposed inside the housing portion 18. Further, a hole portion 18A through which the harness 32 exiting from the socket 30 is inserted is formed in the front wall 18F inside the housing portion 18. The harness 32 is routed through the inside of the rear spoiler 16 to the inside of a vehicle body (hereinafter referred to as a “body”).

The rear portion of the sensor body 24 is a detection unit 26 that transmits and receives a radio wave, and bulges rearward in a substantially arc shape as viewed from the side and as viewed in plan (see FIGS. 3 and 4). The detection unit 26 has a configuration that does not protrude rearward beyond the rear wall surface (hereinafter, referred to as “rear end surface”) of the housing portion 18 as viewed in plan and as viewed from the side (see also FIG. 2) 18B. The detection unit 26 is extended outward in the vehicle width direction, and can detect not only behind the vehicle 10 (detection range E1 in FIG. 4) but also outside the vehicle 10 in the vehicle width direction (detection range E2 in FIG. 4).

The outer wall surface (hereinafter referred to as “outer surface”) 24So in the vehicle width direction of the sensor body 24 does not protrude outward in the vehicle width direction beyond the outer wall surface (hereinafter referred to as “outer surface”) 18So in the vehicle width direction of the housing portion 18 as viewed in plan. The outer surface 18So of the housing portion 18 is tilted inward in the vehicle width direction toward the rear as viewed in plan, and the outer surface 24So of the sensor body 24 is tilted along the outer surface 18So of the housing portion 18 as viewed in plan (see the imaginary line K in FIG. 4).

Next, the operation of the vehicle rear view device 20 according to the present embodiment configured as described above will be described.

As described above, a rear spoiler 16 is mounted on an upper portion of the back glass 14 in the openable/closable back door 12 of the vehicle 10, and a pair of right and left housing portions 18 is integrally mounted at the outer ends in the vehicle width direction of the rear spoiler 16. Sensors 22 are housed in the housing portions 18.

Here, the upper surface 24U of the sensor body 24 of the sensor 22 is attached to the top surface 18U inside the housing portion 18, and the inner surface 24Si thereof is attached to the inner surface 18Si inside the housing portion 18. In other words, the sensor body 24 of the sensor 22 is suspended (supported) between the top surface 18U and the inner surface 18Si inside the housing portion 18, and is not directly attached to the body or the back glass 14. Therefore, for example, it is possible to suppress or prevent a positional deviation of the sensor 22 (the detection unit 26 of the sensor body 24) caused by an impact or vibration generated on the body or the back glass 14 by the opening and closing operation of the back door 12.

Each housing portion 18 is open on the rear side and the outer side in the vehicle width direction, and the detection unit 26 provided at the rear of each sensor body 24 is expanded outward in the vehicle width direction. Therefore, the sensor 22 can accurately detect a wide range and up to a long distance, not only behind the vehicle 10 (detection range E1) but also outside in the vehicle width direction of the vehicle 10 (detection range E2). Therefore, the detection performance of the sensor 22 can be improved as compared with the case where the sensor is provided on the rear side of the rear bumper (not shown).

The sensor 22 is housed inside the housing portion 18. More specifically, the housing portion 18 has an upper wall having a top surface 18U as an inner surface, and the detection unit 26 and the outer surface 24So of the sensor body 24 do not protrude beyond the rear end surface 18B and the outer surface 18So of the housing portion 18, respectively. Therefore, it is possible to suppress or prevent the sensor 22 (sensor body 24) from being exposed to direct sunlight or from being exposed to rain, snow, or the like. Therefore, the durability of the sensor 22 can be increased.

The outer surface 18So of the housing portion 18 is tilted inward in the vehicle width direction toward the rear as viewed in plan, and the outer surface 24So of the sensor body 24 is tilted along the outer surface 18So of the housing portion 18 as viewed in plan. That is, the outer surface 18So of the housing portion 18 and the outer surface 24So of the sensor body 24 serve as rectifying wall surfaces that can rectify the airflow flowing relatively from the front side when the vehicle 10 is traveling. Therefore, it is possible to improve the wind flow at the outer ends in the vehicle width direction of the rear spoiler 16 during traveling of the vehicle 10, so that the aerodynamic performance of the vehicle 10 can be improved.

As described above, the vehicle rear view device 20 according to the present embodiment has been described based on the drawings, but the vehicle rear view device 20 according to the present embodiment is not limited to the illustrated vehicle rear view device, and can be changed in design as appropriate without departing from the gist of the present disclosure. For example, the sensor 22 (detection unit 26 of the sensor body 24) may be configured to emit and receive laser light.

The vehicle 10 need only include an exterior cover, and need not necessarily include the rear spoiler 16. The vehicle 10 is not limited to a vehicle including the back door 12 that is opened and closed together with the back glass 14. That is, the exterior cover (rear spoiler 16) may be provided on the upper portion of the back glass 14 fixed to the body. Further, the exterior cover (rear spoiler 16) may be provided not at the upper portion of the back glass 14 but at the rear end portion of the roof of the vehicle 10.

What is claimed is:

1. A vehicle rear view device comprising:
an exterior cover mounted on an upper portion of a glass on a rear side in such a manner that a longitudinal direction of the exterior cover coincides with a vehicle width direction;
a housing portion mounted at an outer end in the vehicle width direction of the exterior cover, the housing portion being open on a rear side in a vehicle front-rear direction and an outer side in the vehicle width direction; and
a sensor housed in the housing portion, the sensor being supported by a top surface inside the housing portion and an inner side surface in the vehicle width direction of the housing portion.

2. The vehicle rear view device according to claim 1, wherein the sensor does not protrude beyond a rear wall surface in the vehicle front-rear direction of the housing portion and an outer wall surface in the vehicle width direction of the housing portion as viewed in plan.

3. The vehicle rear view device according to claim 1, wherein:
an outer wall surface in the vehicle width direction of the housing portion is tilted inward in the vehicle width direction toward a rear of a vehicle as viewed in plan; and
an outer wall surface in the vehicle width direction of the sensor is tilted along the outer wall surface in the vehicle width direction of the housing portion as viewed in plan.
